(19) United States
(12) Patent Application Publication
(10) Pub. No.: US 2008/0152761 A1
(43) Pub. Date: Jun. 26, 2008

(54) Packaging of Food Products with Pullulan Films

(76) Inventors: Shiji Shen, Forsyth, IL (US); Andrew J. Hoffman, Mount Zion, IL (US); Michael D. Harrison, Decatur, IL (US); Susan E. Butler, Decatur, IL (US); Erin S. Criswell, Decatur, IL (US); Penelope A. Patton, Decatur, IL (US)

Correspondence Address: WILLIAMS, MORGAN & AMERSON, 10333 RICHMOND, SUITE 1100, HOUSTON, TX, 77042, US

(21) Appl. No.: 11/613,365

(22) Filed: Dec. 20, 2006

(51) Int. Cl. A23L 1/05; A23C 19/00; A23L 1/22; A23L 1/40; A23L 2/39; A23L 1/48; A23L 1/32; A23L 1/00

(52) U.S. Cl. 426/89; 426/576; 426/582; 426/589; 426/590; 426/614; 426/650; 426/658

(57) ABSTRACT

An edible article comprises a food product and a film that encloses the food product. In one embodiment, the film comprises a major amount of pullulan on a dry solids basis, and a minor amount of at least two of glycerol, propylene glycol, sorbitol, and polyethylene glycol. In another embodiment, the film comprises a major amount of pullulan on a dry solids basis, gelatin, and at least two of glycerol, propylene glycol, sorbitol, and polyethylene glycol, and can also comprise salt. The edible article can be manufactured by preparing a film-forming composition as described above, forming the film-forming composition into a film, and enclosing a food product with the film.

### BACKGROUND OF THE INVENTION

Some types of packaging material can be dissolved in water. For example, water soluble pouches made from polyvinyl alcohol (PVOH) film have been used to package pre-weighed farm chemicals and concrete additives. These PVOH pouches can be added to tanks or mixers, where the packaging material dissolves and the contents are released. PVOH pouches have also been used with pre-weighed laundry soap and dishwashing detergent. However, PVOH is not a food ingredient, so the PVOH technology has thus far been limited to non-food applications.

Edible films have been made from other film-forming polymers such as pullulan. For example, edible strips containing pullulan and a breath-freshening agent have been sold for human consumption. Cough medicines, vitamins, and dietary supplements have also been supplied in the form of edible strips.

Pullulan has a number of properties that make it suitable for use in edible compositions. However, one problem with pullulan films is their limited ability to elongate without breaking. This problem limits the ability of pullulan films to envelop other materials, as opposed to having other materials interspersed in the film itself. A survey of tensile strength and elongation properties of packaging films indicates that strength above 1,000 gram force and elongation of greater than 50% is likely to give pullulan-based films suitable for commercial packaging.

There is a need for improved methods of enclosing or packaging other materials in pullulan-based films or compositions.

### SUMMARY OF THE INVENTION

One aspect of the invention is an edible article that comprises a food product and a water-soluble film that encloses the food product. The film consists essentially of a major amount of pullulan on a dry solids basis, and a minor amount of more than one member selected from the group consisting of glycerol, propylene glycol, sorbitol, and polyethylene glycol. “Consists essentially of” in this context means that the composition is essentially free of polysaccharides other than those listed.

In some embodiments of the invention, the film comprises about 35-80% by weight pullulan on a dry solids basis. In some embodiments, the film comprises a plasticizer mixture included at up to about 40% by weight. The plasticizer mixture in some embodiments uses a combination of glycerol, propylene glycol, and sorbitol. The film optionally can further comprise citric acid, starch or a starch derivative (such as dextrin or maltodextrin), alginate, xanthan gum, modified cellulose, polydextrose, or a combination of two or more thereof.

In another embodiment of the edible article, the water-soluble film that encloses the food product comprises a major amount of pullulan on a dry solids basis, gelatin, and at least two of glycerol, propylene glycol, sorbitol, and polyethylene glycol. Optionally, the film can also comprise at least one salt, such as NaCl. The film can optionally also comprise at least one internal film release agent.

Another aspect of the invention is a water-soluble, edible film, comprising the above-described components.

Yet another aspect of the invention is a method for making the water-soluble, edible film. The method comprises (a) preparing a film-forming composition as described in various embodiments above, (b) coating a substrate with a solution or suspension comprising at least one surfactant, and (c) casting the film-forming composition on the substrate.

Another aspect of the invention is a method for making an edible article. The method comprises preparing a film-forming composition as described in various embodiments above; forming the film-forming composition into a water-soluble film; and enclosing a food product with the film. The components of the film-forming composition can be as described above.

In some embodiments of the invention, the film can be stretched longitudinally by at least about 50%, or at least about 100%, without breaking. In one embodiment, the food product can be enclosed by placing the food product between two pieces of film and heat-sealing the two pieces of film to form a sealed enclosure around the food product. Alternatively, the food product can be enclosed by placing the food product between two pieces of film and applying moisture and pressure to at least portions of the film to form a sealed enclosure around the food product. One specific method of enclosing that can be used is vacuum-forming the film around the food product.

### DESCRIPTION OF SPECIFIC EMBODIMENTS

The present invention relates to edible articles which contain a food product and can be consumed orally or dissolved (entirely or partially) in water. These articles have an outer layer or surface made from a film-forming composition, and the food product is enclosed inside the outer layer.

The film-forming composition comprises a major amount of pullulan on a dry solids basis. (“A major amount” in this context means that the composition contains more pullulan on a dry solids basis than any other component.) In one embodiment of the invention, the film-forming composition comprises about 35-80% by weight pullulan on a dry solids basis. Optionally, in some embodiments of the invention, other film-forming materials can be included in the film-forming composition as well, such as alginates, xanthan gum, modified cellulose, polydextrose, starch or a starch derivative (such as dextrin or maltodextrin), and combinations of two or more such materials. Inclusion of one or more of these polymers can enhance film strength and reduce cost as compared to pullulan-only compositions.

The film-forming composition also includes a minor amount of plasticizer, in particular at least two of the plasticizers glycerol, propylene glycol, sorbitol, and polyethylene glycol. (“A minor amount” in this context means that the composition contains less total plasticizer than it does pullulan on a dry solids basis.) One commercially available polyethylene glycol that is suitable for use in the invention is polyethylene glycol molecular weight 200 (PEG 200). In one embodiment of the invention, the film-forming composition comprises the plasticizers glycerol, propylene glycol, and sorbitol. For example, the film-forming composition can comprise about 1-30% glycerol, about 1-30% propylene glycol, and about 1-30% by weight sorbitol on a dry solids basis. Each of these materials is commercially available. Optionally, in some embodiments, the composition can also include other plasticizers. In one embodiment of the invention, the film-forming composition comprises a plasticizer mixture at up to about 40% by weight.

A 20% d.s. pullulan solution in water that does not contain any plasticizer, after being cast on Mylar and then dried to residual moisture of 10% or less, results in a clear film that can be peeled away from the Mylar. The film exhibits high tensile strength, but can only be stretched and elongated about 10% in length before it breaks.

In general, pullulan-containing films that also contain plasticizers exhibit increased strength and elongation compared to pullulan films that do not contain plasticizers, up to a point. However, increasing the plasticizer content of a pullulan film beyond this level often leads to greatly decreased tensile strength. For example, addition of individual food grade plasticizers to a pullulan polymer solution prior to casting and drying gave films with elongations above 10%, but at the expense of greatly reduced tensile strength.

Surprisingly, it has been found that pullulan compositions that include at least two of the plasticizers glycerol, propylene glycol, sorbitol, and polyethylene glycol can be used to produce pullulan films that have high elongation and high tensile strength, even at relatively high plasticizer concentrations. In at least some embodiments of the invention, the film can be elongated at least about 50%, and in some cases at least about 100%, without breaking. In certain embodiments, the elongation without breaking is at least about 200%, or at least about 300%. In some embodiments of the invention, these enhancements to the elongation properties of the film are achieved without a substantial reduction in tensile strength.

The composition optionally can also contain one or more additives that are suitable for use in foods, such as fillers, surfactants, stabilizers, organic acids (such as citric acid), and flavorings.

One specific embodiment of the invention is a water-soluble, edible film-forming composition that consists essentially of a major amount of pullulan on a dry solids basis, and a minor amount of more than one member selected from glycerol, propylene glycol, sorbitol, and polyethylene glycol. This composition can be formed into films having a thickness of less than 2.2 mils (0.0022 inches or 0.056 mm) that will exhibit tensile strength in excess of 1,000 grams force and elongation to break in excess of 50%.

In another specific embodiment of the invention, the water-soluble, edible film-forming composition consists essentially of a major amount of pullulan on a dry solids basis and minor amounts of (i) a co-polysaccharide selected from the group consisting of alginates, cellulose ethers, modified starches, and combinations thereof, and (ii) more than one member selected from the group consisting of glycerol, propylene glycol, sorbitol, and polyethylene glycol. (“A minor amount” in this context means that the composition contains less total plasticizer than it does pullulan on a dry solids basis, and also contains less total co-polysaccharide than it does pullulan on a dry solids basis.) The composition can be formed into a film having a thickness of less than 2.2 mils that will exhibit tensile strength in excess of 1,000 grams force and elongation to break in excess of 50%.

In another embodiment of the invention, the film-forming composition that can be used to form a water-soluble, edible film, comprises a major amount of pullulan on a dry solids basis, and also comprises lesser amounts of gelatin and at least two of glycerol, propylene glycol, sorbitol, and polyethylene glycol. The use of gelatin as a secondary polymer can maintain or improve elongation while maintaining film strength. Gelatin also gives the film a smooth surface without increased tackiness and blocking. In certain embodiments, the film-forming composition comprises about 35-80% by weight pullulan and about 0.5-22.5% by weight gelatin on a dry solids basis. Optionally, the composition can comprise the plasticizers glycerol, propylene glycol, and sorbitol. For example, in some embodiments of the invention, the film-forming composition can comprise about 1-30% glycerol, about 1-30% propylene glycol, and about 1-30% by weight sorbitol on a dry solids basis.

Optionally, the composition can also comprise at least one salt. It has been found that the addition of salt to the films improves film elongation. Typically, in order to improve elongation, surface properties are sacrificed such as blocking and tackiness. However, when salt is included in the composition to increase elongation, surface properties in many instances are improved. Films that contain salt and a suitable level of traditional plasticizer, do not block and are not tacky, and therefore can be rolled onto themselves more easily. Examples of suitable salts include NaCl and KCl. In certain embodiments of the invention, the concentration of salt in the film-forming composition is about 0.3-15% by weight on a dry solids basis. Films with a salt content of ˜10% or greater are cloudy with a powder finish as some of the salt precipitates out of the film to the surface on drying. Films with lower salt content of ˜5% or less still have good elongation and surface properties without any residual salt precipitating from the films.

As another option, the film-forming composition can comprise at least one internal film release agent, to make it easier to peel the film from the substrate surface on which it is cast. Suitable examples of internal film release agents include, but are not limited to, polyoxyethylene sorbitan monooleate, sodium lauryl sulfate, and combinations thereof. Polyoxyethylene (20) sorbitan monooleate is commercially available as Polysorbate 80.

Other details of the film-forming composition in this embodiment of the invention, and its use to enclose a food product, can be as discussed above with respect to other embodiments.

Techniques of forming films using pullulan compositions are well known in the art. For example, an aqueous pullulan solution can be cast onto a flat surface, and then heated and dried to form the film. Methods for controlling the thickness of the film are also well known.

In one embodiment of the invention, the water-soluble, edible film is formed by a method comprising preparing a film-forming composition as described above, coating a substrate (e.g., a stainless steel surface) with a solution or suspension that comprises at least one surfactant, and casting the film-forming composition on the substrate. After suitable heating and/or drying, the film can be peeled from the substrate.

Film gels that are cast directly onto a stainless steel substrate often do not release well from the steel, especially films that have 75-125% elongation to break. These types of films will often simply stretch out and become distorted when one attempts to remove them from untreated steel. In order to eliminate or reduce this problem, the steel substrate can be treated with solutions or suspensions that comprise release agents.

The coating of the substrate with the solution or suspension of a food grade surfactant (i.e., an external film release agent) makes it easier to peel the film away from the substrate. Suitable surfactants for this purpose include, but are not limited to, propylene glycol monostearate, sodium stearoyl lactylate, polyoxyethylene sorbitan monooleate (e.g., Polysorbate 80), sodium lauryl sulfate, salts of stearic acid, or a combination thereof. Suitable surfactants can be used in quantities up to 10% by weight in solutions of water and/or alcohol (e.g., isopropyl alcohol), or other suitable solvent systems.

There are many different ways that the film-forming composition can be used to enclose a food product. For example, a film can be formed into a pouch, the food product can be placed in the pouch, and then the opening in the pouch can be sealed, for example by application of heat and/or moisture. One specific technique that can be used is vacuum-forming the film around the food product. Vacuum forming has the advantage of requiring less extreme folding and bending of the film web under tension, as compared to some other methods of enclosing a product with a film.

The food grade films of the present invention can have the tensile strength and elongation properties necessary to successfully produce edible packages on commercial vacuum-forming equipment. They also can have the ability to form many different shapes and work on complex molds more successfully than at least some other commercial film-forming materials. In some embodiments, the films exhibit tensile strength in excess of 1,000 grams force and elongation to break in excess of 50%. In some embodiments, the films have elongation to break of 75-125%.

A wide variety of food products can be encapsulated, including ones that need to be dissolved or dispersed in water for cooking and ones that are supplied in single-serve packages for human consumption. Examples of such food products include, but are not limited to powdered beverage mixes (such as cocoa drink products, soft drink products, and cider drink products), powdered cheese products, powdered egg products, candy, dry soup and casserole mixes, food dyes and spices. The food product itself can be, but does not necessarily have to be, water-soluble.

The edible films of the present invention, at least in many embodiments, have increased elongation without being tacky. The use of such films in the packaging of food products can reduce waste, as the entire package can be consumed, leaving nothing to throw away. When utilized for packaging ingredients needed for batch cooking, the precise amount of ingredient added would be known. There would be no loss of the ingredient by sticking to the inside of the package, since the entire package would be cooked into the product.

### EXAMPLES

The following experimental methods were used in the examples described below.

### Preparation of Pullulan and Other Polymer Solutions

Polymer solutions were prepared to have less than 10,000 centipoises viscosity. Water was placed in a vessel and agitated, and then the dry polymer powder was added to the vortex of the stirring liquid over time. Stirring at 100-1000 rpm was continued for 30-60 minutes, then the solution was allowed to rest for at least two hours prior to use.

### Incorporation of Plasticizers and Other Additives

Polymer solutions were blended as needed to give the desired ratios and concentrations, and then the oligomers, plasticizers, and other additives were added neat to the polymer solutions with mixing over time.

### Film Casting and Drying

Aqueous solutions were cast onto Mylar film by machine or by hand using drawdown bars with a gap of either 20 or 40 mils at a rate of about 1 meter per second. The Mylar film was taped onto 0.50 in thick glass sheets prior to solution casting. The whole assembly (casting, Mylar, and glass) was placed into a controlled drying chamber set for 140° F. and 30% relative humidity (RH) for 2-3 hours to dry the pullulan films.

### Film Conditioning and Testing

Films were conditioned in a controlled environment room set for 70° F. and 50% RH for 1 to 5 days (average 3) prior to testing. Samples were transferred to the testing area in Zip-Loc® bags. Samples were tested and evaluated for tensile strength (gram force) and % elongation using a small laboratory Instron physical testing unit. In the test, a metal probe with an elliptical tip is forced thru the plane of a tightly held piece of film. The amount of force required to break the film, and the distance the probe travels to break the film are used to calculate the material properties.

### Pouch Production via Vacuum Forming

A die was selected and placed on the table under a vertically-movable frame. A sheet of film (7 in×11 in) was placed on the bottom part of the frame. The upper part of the frame was lowered and locked onto the bottom part. A vacuum was pulled through the die, the film was lowered onto the die and sucked into it, forming a pouch, and then the pouch was filled with selected material.

### Heat Sealing

A second piece of film was laid smoothly on top of the pouch. A hot iron (200-300° F.) was manually pressed onto both pieces of film at the edge of the filled area. The iron was held in place for 2-5 seconds.

### Moisture Sealing

A second piece of film was wrapped around a block and was quickly pressed into a damp paper towel. The lightly moisturized film was pressed onto the previously formed pouch for about 2-5 seconds.

### Example 1

Commercially available pullulan from Hayashibara (PI-20) was used to prepare films with one or more of the following additives: glycerol, propylene glycol (PPG), Sorbitol Special (SorbS; SPI Pharma; 40-55% sorbitol, 15-30% sorbitol anhydrides, and 1-10% mannitol), Nu-Col 2004 (NC2004; Tate & Lyle modified starch), Star-Dri 5 (Tate & Lyle maltodextrin), MiraSperse 2000 (MS2000; Tate & Lyle modified starch), DuraGel (Tate & Lyle modified starch), TenderJel C (Tate & Lyle modified starch), and sodium alginate. The specific compositions are shown in Table 1A.

TABLE 1A

| Ref. No. | total % d.s. | % pullulan | additive 1 | % additive 1 | % glycerol | % PPG | % SorbS |
|---|---|---|---|---|---|---|---|
| 1-1 | 20.0% | 80.0% | | | 20.0% | | |
| 1-2 | 20.0% | 48.0% | Na alginate | 12.0% | 10.0% | 10.0% | 20.0% |
| 1-3 | 20.0% | 48.0% | NC2004 | 12.0% | 10.0% | 10.0% | 20.0% |
| 1-4 | 20.0% | 48.0% | Star-Dri 5 | 12.0% | 10.0% | 30.0% | |
| 1-5 | 20.0% | 80.0% | Star-Dri 5 | 20.0% | | | |
| 1-6 | 20.0% | 48.0% | Na alginate | 12.0% | 10.0% | 30.0% | |
| 1-7 | 20.0% | 80.0% | TenderJel C | 20.0% | | | |
| 1-8 | 20.0% | 48.0% | DuraGel | 12.0% | 10.0% | 30.0% | |
| 1-9 | 20.0% | 80.0% | DuraGel | 20.0% | | | |
| 1-10 | 34.0% | 48.9% | MS2000 | 12.0% | 9.8% | 29.3% | |
| 1-11 | 37.0% | 41.9% | MS2000 | 24.6% | 8.3% | 25.1% | |
| 1-12 | 20.0% | 48.0% | NC2004 | 12.0% | 10.0% | 30.0% | |
| 1-13 | 20.0% | 80.0% | MS2000 | 20.0% | | | |
| 1-14 | 20.0% | 80.0% | NC2004 | 20.0% | | | |
| 1-15 | 20.0% | 80.0% | | | | 20.0% | |
| 1-16 | 20.0% | 80.0% | | | 20.0% | | |

### The results of tests of the film properties are given in Table 1B.

TABLE 1B

| | Film | | | | |
|---|---|---|---|---|---|
| | Thickness | Force | Elongation | Force | |
| Ref. No. | (mil) | (gram) | (percent) | (coeff. var.) | N |
| 1-1 | 2.0 | 2,018 | 15% | 15% | 3 |
| 1-2 | 2.2 | 1,068 | 62% | 9% | 5 |
| 1-3 | 2.2 | 841 | 57% | 15% | 5 |
| 1-4 | 2.6 | 1,666 | 22% | 5% | 4 |
| 1-5 | 2.0 | 3,174 | 12% | 16% | 4 |
| 1-6 | 1.7 | 1,069 | 7% | 32% | 5 |
| 1-7 | 2.4 | 2,114 | 5% | 12% | 4 |
| 1-8 | 1.6 | 827 | 5% | 10% | 4 |
| 1-9 | 3.0 | 1,818 | 4% | 3% | 4 |
| 1-10 | 2.8 | 763 | 4% | 3% | 5 |
| 1-11 | 3.1 | 755 | 4% | 4% | 5 |
| 1-12 | 1.8 | 569 | 3% | 22% | 4 |
| 1-13 | 2.0 | 1,113 | 2% | 12% | 4 |
| 1-14 | 2.0 | 981 | 2% | 34% | 4 |
| 1-15 | 2.4 | 857 | 2% | 15% | 5 |
| 1-16 | 2.4 | 1,988 | 17% | 4% | 4 |

Films containing a combination of three plasticizers (glycerol, propylene glycol and sorbitol special) gave elongations above 50% at high strength in samples 1-2 and 1-3.

### Example 2

Films were prepared containing pullulan and additional ingredients shown in Table 2A.

TABLE 2A

| Ref. No. | total % d.s. | % pullulan | % Na alginate | % Star-Dri 5 | % NC2004 | % glycerol | % PPG | % SorbS | % citric acid |
|---|---|---|---|---|---|---|---|---|---|
| 2-1 | 20.0% | 80.0% | | | | 20.0% | | | |
| 2-2 | 22.8% | 56.0% | 2.8% | 11.2% | | 5.0% | 10.0% | 15.0% | |
| 2-3 | 25.0% | 56.0% | 2.8% | 11.2% | | | 12.0% | 18.0% | |
| 2-4 | 25.0% | 56.0% | 2.8% | 11.2% | | | 10.0% | 20.0% | |
| 2-5 | 30.0% | 56.0% | 2.8% | 8.4% | 2.8% | 0.0% | 10.0% | 20.0% | 0.0% |
| 2-6 | 30.0% | 56.0% | 2.8% | 8.4% | 2.8% | | | 20.0% | 10.0% |
| 2-7 | 25.0% | 56.0% | 2.8% | 11.2% | | | | 20.0% | 10.0% |
| 2-8 | 25.0% | 56.0% | 2.8% | 11.2% | | 5.0% | 10.0% | 15.0% | |
| 2-9 | 25.0% | 56.0% | 2.8% | 11.2% | | | 10.0% | 20.0% | |
| 2-10 | 25.0% | 48.0% | 2.4% | 9.6% | | 10.0% | 10.0% | 20.0% | |
| 2-11 | 30.0% | 56.0% | 2.8% | 8.4% | 2.8% | 0.0% | 12.0% | 18.0% | |
| 2-12 | 25.0% | 53.2% | 2.8% | 11.2% | 2.8% | 5.0% | 10.0% | 15.0% | |
| 2-13 | 25.0% | 56.0% | 2.8% | 11.2% | | 5.0% | 10.0% | 15.0% | |
| 2-14 | 30.0% | 48.0% | 2.4% | 7.2% | 2.4% | 10.0% | 10.0% | 20.0% | |
| 2-15 | 30.0% | 48.0% | 2.4% | 7.2% | 2.4% | 10.0% | 10.0% | 20.0% | |
| 2-16 | 24.0% | 57.0% | 2.6% | 10.4% | | 5.0% | 10.0% | 15.0% | |
| 2-17 | 30.0% | 48.0% | 2.4% | 7.2% | 2.4% | 10.0% | 10.0% | 20.0% | |
| 2-18 | 25.0% | 50.4% | 2.4% | 7.2% | | 5.0% | 10.0% | 15.0% | 10.0% |
| 2-19 | 25.0% | 52.0% | 2.6% | 10.4% | | 5.0% | 5.0% | 15.0% | 10.0% |
| 2-20 | 25.0% | 56.0% | 2.8% | 11.2% | | 5.0% | 5.0% | 15.0% | 5.0% |
| 2-21 | 26.4% | 48.0% | 2.4% | 9.6% | | 5.0% | 10.0% | 15.0% | 10.0% |
| 2-22 | 24.0% | 57.0% | 2.6% | 10.4% | | 5.0% | 10.0% | 15.0% | |
| 2-23 | 24.0% | 48.0% | 2.4% | 9.6% | | 5.0% | 10.0% | 15.0% | 10.0% |
| 2-24 | 25.0% | 56.0% | 2.8% | 11.2% | | 5.0% | 10.0% | 15.0% | |

Tests were performed to determine the properties of these films, and the results are given in Table 2B.

TABLE 2B

| | Film | | | | |
|---|---|---|---|---|---|
| | Thickness | Force | Elongation | Force | |
| Ref. No. | (mil) | (gram) | (percent) | (coeff. var.) | N |
| 2-1 | 2.8 | 1,644 | 10% | 9% | 5 |
| 2-2 | 5.9 | 3,820 | 90% | 4% | 4 |
| 2-3 | 5.1 | 2,799 | 111% | 3% | 3 |
| 2-4 | 5.6 | 2,766 | 103% | 17% | 5 |
| 2-5 | 5.4 | 2,570 | 93% | 16% | 5 |
| 2-6 | 5.6 | 2,417 | 83% | 9% | 3 |
| 2-7 | 5.5 | 2,396 | 67% | 3% | 5 |
| 2-8 | 5.2 | 2,374 | 122% | 3% | 4 |
| 2-9 | 6.1 | 2,080 | 266% | 5% | 5 |
| 2-10 | 6.3 | 1,908 | 161% | 5% | 5 |
| 2-11 | 5.5 | 1,892 | 151% | 9% | 5 |
| 2-12 | 4.3 | 1,581 | 271% | 4% | 3 |
| 2-13 | 4.4 | 1,500 | 133% | 10% | 5 |
| 2-14 | 2.2 | 1,277 | 65% | 11% | 4 |
| 2-15 | 2.2 | 1,246 | 55% | 2% | 5 |
| 2-16 | 5.5 | 1,188 | 275% | 9% | 5 |
| 2-17 | 2.1 | 1,166 | 60% | 4% | 5 |
| 2-18 | 4.9 | 1,156 | 342% | 5% | 5 |
| 2-19 | 5.5 | 1,127 | 193% | 9% | 5 |
| 2-20 | 4.7 | 1,099 | 215% | 14% | 5 |
| 2-21 | 6.0 | 1,056 | 213% | 5% | 5 |
| 2-22 | 4.7 | 1,028 | 231% | 3% | 5 |
| 2-23 | 5.4 | 1,025 | 350% | 8% | 5 |
| 2-24 | 2.1 | 1,019 | 105% | 10% | 5 |

The films made with STAR-DRI 5 maltodextrin and sodium alginate (and optionally Nu-Col 2004) with pullulan as the predominant polymer showed high tensile strength. High elongations were seen in films containing glycerol, propylene glycol and sorbitol (and optionally citric acid) with pullulan as the predominant polymer. Variations in thickness resulted in films with tensile strength in excess of 1,000 grams force and elongation to break in excess of 50%.

### Example 3

The following films were prepared for testing on a laboratory vacuum forming packaging apparatus:

TABLE 3A

| | Total % | | % Na | % Star- | | | | other | % other |
|---|---|---|---|---|---|---|---|---|---|
| Ref. No. | d.s. | % pullulan | alginate | Dri 5 | % glycerol | % PPG | % SorbS | additive(s) | additives(s) |
| 1 | 20.0 | 80.0 | | 20.0 | | | | | |
| 2 | 24.8 | 60.0 | 3.0 | 12.0 | 6.3 | 6.3 | 12.5 | | |
| 3 | 25.0 | 56.0 | 2.8 | 11.2 | | 10.0 | 20.0 | | |
| 4 | 25.0 | 56.0 | 2.8 | 11.2 | 5.0 | 10.0 | 15.0 | | |
| 5 | 25.0 | 50.4 | 2.4 | 7.2 | 5.0 | 10.0 | 15.0 | citric acid | 10.0 |
| 6 | 24.1 | 52.0 | 2.6 | 7.8 | 10.0 | 10.0 | 15.0 | NC2004/ | 26/10.0 |
| | | | | | | | | citric acid | |

Tests were performed to evaluate the film properties, and the results are shown in Table 3B.

TABLE 3B

| Film | Film | Force | Elongation | Force | |
|---|---|---|---|---|---|
| Ref. No. | Thickness (mil) | (gram) | (%) | (% coeff. var.) | N |
| 1 | 2.1 | 3,174 | 12 | 8 | 5 |
| 2 | 2.6 | 1,600 | 47 | 14 | 5 |
| 3 | 2.2 | 2,766 | 100 | 17 | 5 |
| 4 | 5.9 | 1,500 | 130 | 10 | 5 |
| 5 | 6.0 | 1,131 | 250 | 5 | 5 |
| 6 | 5.8 | 879 | 216 | 9 | 5 |

The following dies were used in the vacuum packaging tests:

Die 1) Half egg-shaped: 2.50 in L by 1.88 in W by 0.69 in D—maximum depth tapered down from edge.

Die 2) Rectangular: 4.50 in L by 2.75 in W by 0.50 in D—uniform depth straight down from edge.

Die 3) Half tube: 1.88 in L by 0.75 in W by 0.50 in D—maximum depth tapered down from edge.

Die 4) Seven half cylinders: 2.00 in L by 0.75 in W by 0.50 in D—maximum depth tapered down from edge, each cylinder spaced 0.38″ apart.

Die 5) Tapered Square: 1.88 in L by 1.88 in W by 0.75 in D—maximum depth tapered down from edge.

Various food products were enclosed with the films as described below, forming edible, water soluble packages.

Example 3-1—Film #6 was successfully vacuum formed using Die #1 and about 12 grams of finely powdered ALLEGGRA® FS74 egg product was filled in the pouch. Film #1 was successfully used to close the package by heat sealing.

Example 3-2—Film #5 was successfully vacuum formed using Die #1 and about 20 grams of finely powdered Swiss Miss® Hot Cocoa Mix was filled in the pouch. Film #1 was unsuccessfully used to close the package due to fracture during heat sealing.

Example 3-3—Film #5 was successfully vacuum formed using Die #1 and about 12 grams of finely powdered ALLEGGRA® FS74 egg product was filled in the pouch. Film #5 was successfully used to close the package by heat sealing.

Example 3-4—Film #3 was successfully vacuum formed using Die #1 and about 20 grams of finely powdered Swiss Miss® Hot Cocoa Mix was filled in the pouch. Film #3 was successfully used to close the package by heat sealing.

Example 3-5—Film #4 was successfully vacuum formed using Die #1 and about 12 grams of finely powdered ALLEGGRA® FS74 egg product was filled in the pouch. Film #4 was successfully used to close the package by heat sealing.

Example 3-6—Film #4 was successfully vacuum formed using Die #2 and about 28 grams of finely powdered Swiss Miss® Hot Cocoa Mix was filled in the pouch. Film #4 was successfully used to close the package by heat sealing. This package was later found to have a minute hole in the deep corner of a vacuum formed region.

Example 3-7—Film #3 was successfully vacuum formed using Die #2 and about 40 grams of finely powdered Swiss Miss® Hot Cocoa Mix was filled in the pouch. Film #3 was successfully used to close the package by heat sealing.

Example 3-8—Film #4 was successfully vacuum formed using Die #2 and about 28 grams of finely powdered Swiss Miss® Hot Cocoa Mix was filled in the pouch. Film #4 was successfully used to close the package by heat sealing. This package was a redo of Example 5-6 and showed no defects.

Example 3-9—Film #1 was unsuccessfully vacuum formed using Die #2. The film shattered to bits.

Example 3-10—Film #2 was successfully vacuum formed using Die #2 and about 24 grams of finely powdered ALLEGGRA® FS74 egg product was filled in the pouch. Film #4 was successfully used to close the package by heat sealing. This package was later found to have a leak due to a heat sealing defect.

Example 3-11—Film #5 was successfully vacuum formed using Die #3 and about 5 grams of finely powdered Crystal Light® Soft Drink Mix was filled in the pouch. Film #4 was successfully used to close the package by heat sealing.

Example 3-12—Film #5 was successfully vacuum formed using Die #4 and about 5 grams of finely powdered Crystal Light® Soft Drink Mix was filled in each of seven pouches. Film #5 was successfully used to close the package by heat sealing. This film was capable of filling multiple adjacent cavities in a single vacuum forming operation.

Example 3-13—Film #6 was successfully vacuum formed using Die #4 and about 4 grams of finely powdered Alpine® Spiced Cider Sugar Free Drink Mix was filled in each of seven pouches. Film #6 was successfully used to close the package by heat sealing. This film was capable of filling multiple adjacent cavities in a single vacuum forming operation.

Example 3-14—Film #4 was successfully vacuum formed using Die #4 and about 5 grams of finely powdered Easy Mac® Cheese Powder was filled in each of seven pouches. Film #4 was successfully used to close the package by heat sealing. This film survived but seemed to be at the limit of its elongation and gave audible signs of stress during vacuum forming.

Example 3-15—Film #3 was successfully vacuum formed using Die #1 and about 17 grams of finely powdered Easy Mac® Cheese Powder was filled in the pouch. Film #3 was successfully used to close the package by heat sealing.

Example 3-16—Film #2 was successfully vacuum formed using Die #1 and about 17 grams of finely powdered Easy Mac® Cheese Powder was filled in the pouch. Film #3 was successfully used to close the package by heat sealing. This package was later found to have a leak due to a heat sealing defect.

Example 3-17—Film #4 was successfully vacuum formed using Die #2 and about 40 grams of finely powdered Easy Mac® Cheese Powder was filled in the pouch. Film #4 was successfully used to close the package by heat sealing. This package was later found to have a leak due to a heat sealing defect.

Example 3-18—Film #3 was successfully vacuum formed using Die #1 and about 17 grams of finely powdered Easy Mac® Cheese Powder was filled in the pouch. Film #3 was successfully used to close the package by water sealing.

Example 3-19—Film #5 was successfully vacuum formed using Die #5 and about 8 grams of finely powdered Easy Mac® Cheese Powder was filled in the pouch. Film #5 was successfully used to close the package by water sealing.

Example 3-20—Film #3 (at 6 mil) was successfully vacuum formed using Die #5 and about 8 grams of finely powdered Easy Mac® Cheese Powder was filled in the pouch. Film #3 (at 6 mil) was successfully used to close the package by water sealing.

Example 3-21—A blue colored and peppermint flavored film of 2 mil thickness was made using the following ingredients (all in % w/w, d.s. basis): pullulan (PI-20) 50%, tapioca dextrin (F4-800) 13%, glycerol 6%, propylene glycol 13%, and sorbitol 19%. The film was formed into a small ½ inch square pouch using a laboratory impulse sealer. Each pouch was filled with about 0.25 g of strawberry flavored Pop Rocks® candy and sealed. Thus, this test produced an edible, two-part confectionary where the immediate flavor of the film is supplanted by the flavor and sensory attributes of the Pop Rocks® candy once the film is dissolved in the mouth.

### Example 4

A 100 g film solution is prepared by dissolving 15.46 g pullulan in 80 g deionized water. To this 1.142 g glycerin, 2.28 g sorbitol, 0.572 g propylene glycol, 0.01 g sodium lauryl sulfate, 0.01 g Polysorbate-80, and 0.02 g sodium benzoate are added with stirring. Finally, 0.5 g gelatin-1385P was added with stirring. The solution is heated to 70° C. for 30 minutes to fully dissolve the gelatin. The solution is continually stirred as it cools to room temperature which keeps the gelatin in solution. The gel is degassed by either sitting overnight or centrifuging. The gels are then cast onto treated stainless steel and dried to a moisture level of 7.5-9.5%. The film can then be peeled from the steel.

### Example 5

A 100 g film solution is prepared by dissolving 14.76 g pullulan in 80 g deionized water. To this 1.334 g glycerin, 2.66 g sorbitol, 0.2 g propylene glycol, 1 g NaCl, 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be peeled from the steel.

### Example 6

A 100 g film solution is prepared by dissolving 14.96 g pullulan in 80 g deionized water. To this 1.6 g sorbitol, 1.4 g polyethylene glycol, 2 g NaCl, 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be peeled from the steel.

### Example 7

Film samples prepared according to Examples 4-6 (labeled samples 4a, 5a, and 6a in the table below) were tested to determine their tensile strength and percent elongation to break. The same tests were also performed on comparison film samples (labeled as samples 4b, 5b, and 6b in the following table) that contained the same ingredients, except that they contained no gelatin or salt.

### Film Testing Protocol

To measure tensile strength and elongation to break, a sample of film is placed between two aluminum blocks, which are held securely together by screws and wing nuts. The blocks have an identical pattern of five holes drilled through them. A cylindrical probe is attached to the arm of an Instron testing unit. The test is run by punching the probe through the film. Five repetitions are performed—one test per hole—without reloading the sample. The block is merely re-positioned to align a new hole with the probe. Calculations use the data averaged from all runs.

The Instron software is programmed to start measuring when there is 1 gf recorded on the load cell, and records the distance the probe travels beyond this, through the hole drilled in the bottom plate. As the probe travels through the hole in the bottom plate, the film is distended and finally ruptures. As well as deformation, the instrument also records the resistance the film exerts over the course of deformation as gram force exerted on the load cell. Even though the film is being pushed rather than pulled in this test, the data can be treated as a conventional tensile test.

Film strain can be determined as follows. The film is stretched between the tip of the probe and the supporting edge of the blocks. The initial “length” of the test sample is defined as the radius of the hole (“a”). The distended length can be calculated from this initial length and the distance the probe has traveled. The distended length is essentially the hypotenuse of a right triangle, with the hole radius, a as one side of the triangle and distance traveled by the probe, b, as the second side. The distended length of the film, c, (the hypotenuse), can be calculated:

c²=a²+b².

c=(a²+b²)^{1/2}.

The diameter of each hole is 13 mm, so the radius is 6.5 mm. Strain is calculated as follows:

$$Strain = \frac{( distended length , c - 6.5 )}{6.5}$$

Percent elongation is the strain presented as a percentage rather than a fraction.

The cross sectional area of the probe tip is 0.0085 cm². To calculate the tensile strength, the force at break or maximum load force is divided by the cross sectional area. Since the force is recorded in grams, it is then divided by 1000 to obtain the result in Kgf/sq cm. The calculation is as follows:

Tensile Strength=max. force(gf)/0.0085 sqcm/1000

### Blocking Analysis

In order to measure the blocking of the films, a subjective test is used. For this test, three pieces of film are cut and placed overlapping, front-to-back on a piece of Mylar, and then covered with another piece of Mylar. A ½-inch thick sheet of glass is placed on top of the stack in order to apply pressure to the films. After one week the films are peeled apart and scored as to ease of peel by the following scale:

0: Not blocking

1: Easily pulls apart

2: Pulls apart with some effort

3: Pulls apart with great effort either tearing a piece or only one piece will peel off.

4: Completely stuck. Does not peel apart.

The results of these tests are summarized in Table 4 below:

TABLE 4

| | | Tensile strength | | Blocking score |
|---|---|---|---|---|
| Sample | Additive | (kg/sq cm) | Elongation % | (0–4) |
| 4a | gelatin | 278.7 | 73.3 | 2 |
| 4b | none | 359 | 50.4 | 2 |
| 5a | 5% NaCl | 141.4 | 402.4 | 4 |
| 5b | none | 351.3 | 49.2 | 1 |
| 6a | 10% NaCl | 292.1 | 125 | 1 |
| 6b | none | 350.5 | 103.2 | 4 |

The data indicate that both gelatin and salt can improve elongation. While the gelatin films usually require some other additive to combat blocking, the gelatin does not make blocking worse than similar films with less elongation. The data also indicates that salt can drastically improve elongation, and when used with r lower levels of plasticizers, it can greatly improve blocking as well.

### Example 8

A 100 g surfactant solution is made by dissolving 5 g of sodium stearoyl lactylate in 95 g isopropyl alcohol. This is then sprayed or mopped onto stainless steel in a thin even layer and the liquid allowed to evaporate. Film gels may then be cast onto the treated surface and dried.

### Example 9

A 100 g surfactant solution is made by dissolving 5 g of propylene glycol monostearate in 95 g isopropyl alcohol. This is then sprayed or mopped onto stainless steel in a thin even layer and the liquid allowed to evaporate. Film gels may then be cast onto the treated surface and dried.

### Example 10

A 100 g surfactant solution is made by dissolving 5 g of sodium lauryl sulfate in 95 g deionized water. This is then sprayed or mopped onto stainless steel in a thin even layer and the liquid allowed to evaporate. Film gels may then be cast onto the treated surface and dried.

### Example 11

A 100 g surfactant solution is made by dissolving 5 g of Polysorbate-80 in 95 g deionized water. This is then sprayed or mopped onto stainless steel in a thin even layer and the liquid allowed to evaporate. Film gels may then be cast onto the treated surface and dried.

### Example 12

In order to test the solutions prepared in Examples 8-11, a separate sheet of stainless steel was wiped down with each surfactant solution and the liquid allowed to evaporate off. This left an evenly coated surface on each piece of stainless steel. Six different film gels which have proven difficult to peel on untreated steel were prepared and cast onto the four different steel surfaces. The film gels were formulated as follows:

Film Sample 12-1

A 100 g film solution is prepared by dissolving 14.96 g pullulan in 80 g deionized water. To this 2.26 g diglycerol, 2.26 g polyethylene glycol, 0.5 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-2

A 100 g film solution is prepared by dissolving 14.96 g pullulan in 80 g deionized water. To this 1 g diglycerol, 1 g polyethylene glycol, 3 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-3

A 100 g film solution is prepared by dissolving 14.96 g pullulan in 80 g deionized water. To this 2 g diglycerol, 2 g polyethylene glycol, 1 g KCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-4

A 100 g film solution is prepared by dissolving 14.96 g pullulan in 80 g deionized water. To this 2 g diglycerol, 2 g polyethylene glycol, 1 g Na₂SO₄, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-5

A 100 g film solution is prepared by dissolving 14.96 g pullulan in 80 g deionized water. To this 2.26 g diglycerol, 2.26 g sorbitol, 0.5 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

Film Sample 12-6

A 100 g film solution is prepared by dissolving 14.96 g pullulan in 80 g deionized water. To this 1.5 g diglycerol, 1.5 g sorbitol, 2 g NaCl, 0.01 g sodium lauryl sulfate, 0.01 g Polysorbate-80, and 0.02 g sodium benzoate are added with stirring. The gel is degassed by either sitting overnight or centrifuging. The gel is then cast onto the four different treated stainless steel sheets and dried to a moisture level of 7.5-9.5%.

After drying, the films were all cured in an environmental chamber for 18 hours at 22.5° C. and 45% relative humidity. The films were then peeled off of the stainless steel and ranked as to ease of peel for each film, with 1 being the easiest and 4 the most difficult. The results are shown in Table 5.

TABLE 5

| Film Sample | Example 8 | Example 9 | Example 10 | Example 11 |
|---|---|---|---|---|
| 12-1 | 1 | 2 | 4 | 3 |
| 12-2 | 1 | 1 | 4 | 3 |
| 12-3 | 1 | 2 | 4 | 3 |
| 12-4 | 1 | 2 | 4 | 3 |
| 12-5 | 1 | 2 | 3 | 3 |
| 12-6 | 1 | 2 | 4 | 3 |

The solutions of Examples 8 and 9 allowed for the easiest peeling of the films from the steel substrate. However, the solutions of Examples 10 and 11 also peeled quite easily, and could be used for removal from a steel belt in a commercial setting as well.

### Example 13

Films similar to those shown in Examples 1-3 were made. These films were as follows:

Film 13-1. A 100 g film solution is prepared by dissolving 15.26 g pullulan in 80 g deionized water. To this 1.2 g glycerin, 2.4 g sorbitol, 0.6 g diglycerol, 0.01 g sodium lauryl sulfate, 0.01 g Polysorbate-80, and 0.02 g sodium benzoate are added with stirring. Finally, 0.5 g gelatin-1385P was added with stirring. The solution is heated to 70° C. for 30 minutes to fully dissolve the gelatin. The solution is continually stirred as it cools to room temperature which keeps the gelatin in solution. The gel is degassed by either sitting overnight or centrifuging. The gels are then cast onto treated stainless steel and dried to a moisture level of 7.5-9.5%. The film can then be easily peeled from the steel for use.

Film 13-2. A 100 g film solution is prepared by dissolving 15.76 g pullulan in 80 g deionized water. To this 1.2 g glycerin, 2.4 g sorbitol, 0.6 g diglycerol, 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be easily peeled from the steel for use.

Film 13-3. A 100 g film solution is prepared by dissolving 15.14 g pullulan in 80 g deionized water. To this 0.48 g glycerin, 0.86 g sorbitol, 1.48 g polyethylene glycol (MW=200), 0.01 g sodium lauryl sulfate, 0.01 g Polysorbate-80, 2 g NaCl, and 0.02 g sodium benzoate are added with stirring. The gel is degassed by either sitting overnight or centrifuging. The gels are then cast onto treated stainless steel and dried to a moisture level of 7.5-9.5%. The film can then be easily peeled from the steel for use.

Film 13-4. A 100 g film solution is prepared by dissolving 16.14 g pullulan in 80 g deionized water. To this 0.48 g glycerin, 0.86 g sorbitol, 1.48 g polyethylene glycol (MW=200), 0.01 g sodium lauryl sulfate, 0.01 g Polysorbate-80, 1 g NaCl, and 0.02 g sodium benzoate are added with stirring. The gel is degassed by either sitting overnight or centrifuging. The gels are then cast onto treated stainless steel and dried to a moisture level of 7.5-9.5%. The film can then be easily peeled from the steel for use.

Film 13-5. A 100 g film solution is prepared by dissolving 17.14 g pullulan in 80 g deionized water. To this 0.48 g glycerin, 0.86 g sorbitol, 1.48 g polyethylene glycol (MW=200), 0.01 g sodium lauryl sulfate, 0.01 g Polysorbate-80, and 0.02 g sodium benzoate are added with stirring. The gel is degassed by either sitting overnight or centrifuging. The gels are then cast onto treated stainless steel and dried to a moisture level of 7.5-9.5%. The film can then be easily peeled from the steel for use.

These five films underwent tensile testing on an Instron 5542 tester by method ASTM D882 using Bluehill 2 software. The gage length, film thickness, and strain rate used for each test is given in the table below. Multiple samples were run for each film and the resulting data is calculated by the software. The tensile strength and break elongation percent for each film is determined from these calculations. The results are shown in the following table.

| | Gage | Strain | Film | Tensile | Break | |
|---|---|---|---|---|---|---|
| | Length | Rate | Thickness | Strength | Elongation | No. of |
| Film | (in) | (mm/min) | (mil) | (kgf/cm²) | (%) | samples |
| 1 | 2 | 500 | 2.5 | 173.2 | 150.3 | 6 |
| 2 | 4 | 50 | 3.8 | 279.3 | 8.4 | 5 |
| 3 | 4 | 50 | 3.7 | 85.3 | 110 | 6 |
| 4 | 4 | 50 | 3.7 | 325.4 | 3.6 | 5 |
| 5 | 4 | 50 | 4.0 | 416.2 | 2.2 | 5 |

As is seen in the above table, both gelatin and salt greatly improve the elongation of pullulan films. Films 13-1 and 13-2, which both contained 21% plasticizer, showed much different elongation values. Without the gelatin (film 2), the film has a break elongation of only 8.4%, while with gelatin, the break elongation increases to 150.3%. Films 13-3, 13-4, and 13-5, which all contain only 14% plasticizer, also show widely different elongations. At this low plasticizer level, little increase in elongation is seen with the addition of only 5% salt. However, when adding 10% salt the break elongation jumps to 110%. The strength was greatly reduced at these high levels of salt. In films with slightly higher levels of traditional plasticizers, the addition of 5% salt also gives much better elongation, as is seen in the previous examples.

The preceding description of certain embodiments of the invention is not intended to be an exhaustive list of all possible embodiments. Persons skilled in this field will appreciate that modifications could be made to the specific embodiments described herein which would be within the scope of the following claims.

1. An edible article, comprising a food product and a water-soluble film that encloses the food product, wherein the film consists essentially of a major amount of pullulan on a dry solids basis, and a minor amount of more than one member selected from glycerol, propylene glycol, sorbitol, and polyethylene glycol.

2-32. (canceled)

33. An edible article, comprising a food product and a water-soluble film that encloses the food product, wherein the film comprises:
a major amount of pullulan on a dry solids basis;
gelatin; and
at least two of glycerol, propylene glycol, sorbitol, and polyethylene glycol.

34. The edible article of claim 33, wherein the film comprises about 35-80% by weight pullulan on a dry solids basis.

35. The edible article of claim 33, wherein the film comprises about 0.5-22.5% by weight gelatin on a dry solids basis.

36. The edible article of claim 33, wherein the film comprises glycerol, propylene glycol, and sorbitol.

37. The edible article of claim 36, wherein the film comprises about 1-30% glycerol, about 1-30% propylene glycol, and about 1-30% by weight sorbitol on a dry solids basis.

38. The edible article of claim 33, wherein the film further comprises at least one salt.

39. The edible article of claim 38, wherein the at least one salt comprises NaCl.

40. The edible article of claim 38, wherein the at least one salt is present in the film at a concentration of about 0.3-15% by weight on a dry solids basis.

41. The edible article of claim 33, wherein the film further comprises at least one internal film release agent.

42. The edible article of claim 41, wherein the at least one internal film release agent comprises polyoxyethylene sorbitan monooleate, sodium lauryl sulfate, or a combination thereof.

43. The edible article of claim 33, wherein the food product is selected from powdered beverage mix, candy, powdered cheese product, powdered egg product, dry soup and casserole mixes, food dyes and spices.

44. A water-soluble, edible film, comprising:
a major amount of pullulan on a dry solids basis;
gelatin; and
at least two of glycerol, propylene glycol, sorbitol, and polyethylene glycol.

45. The film of claim 44, wherein the film comprises about 35-80% by weight pullulan on a dry solids basis.

46. The film of claim 44, wherein the film comprises about 0.5-22.5% by weight gelatin on a dry solids basis.

47. The film of claim 44, wherein the film comprises glycerol, propylene glycol, and sorbitol.

48. The film of claim 47, wherein the film comprises about 1-30% glycerol, about 1-30% propylene glycol, and about 1-30% by weight sorbitol on a dry solids basis.

49. The film of claim 44, further comprising at least one salt.

50. The film of claim 49, wherein the at least one salt comprises NaCl.

51. The film of claim 49, wherein the at least one salt is present in the film at a concentration of about 0.3-15% by weight on a dry solids basis.

52. The film of claim 49, further comprising at least one internal film release agent.

53. The film of claim 52, wherein the at least one internal film release agent comprises polyoxyethylene sorbitan monooleate, sodium lauryl sulfate, or a combination thereof.

54. A method for making a water-soluble, edible film, comprising:
(a) preparing a film-forming composition that comprises:
a major amount of pullulan on a dry solids basis;
gelatin; and
at least two of glycerol, propylene glycol, sorbitol, and polyethylene glycol;
(b) coating a substrate with a solution or suspension comprising at least one surfactant; and
(c) casting the film-forming composition on the substrate.

55. The method of claim 54, wherein the at least one surfactant comprises propylene glycol monostearate, sodium stearoyl lactylate, polyoxyethylene sorbitan monooleate, sodium lauryl sulfate, at least one salt of stearic acid, or a combination thereof.

56. The method of claim 54, wherein the film-forming composition comprises about 35-80% by weight pullulan on a dry solids basis.

57. The method of claim 54, wherein the film-forming composition comprises about 0.5-22.5% by weight gelatin on a dry solids basis.

58. The method of claim 54, wherein the film-forming composition comprises glycerol, propylene glycol, and sorbitol.

59. The method of claim 58, wherein the film-forming composition comprises about 1-30% glycerol, about 1-30% propylene glycol, and about 1-30% by weight sorbitol on a dry solids basis.

60. The method of claim 54, wherein the film-forming composition further comprises at least one salt.

61. The method of claim 60, wherein the at least one salt comprises NaCl.

62. The method of claim 60, wherein the at least one salt is present in the film-forming composition at a concentration of about 0.3-15% by weight on a dry solids basis.

63. The method of claim 54, wherein the film-forming composition further comprises at least one internal film release agent.

64. The method of claim 63, wherein the at least one internal film release agent comprises polyoxyethylene sorbitan monooleate, sodium lauryl sulfate, or a combination thereof.

65. A method for making an edible article, comprising:
preparing a film-forming composition that comprises a major amount of pullulan on a dry solids basis, gelatin, and at least two of glycerol, propylene glycol, sorbitol, and polyethylene glycol;
forming the film-forming composition into a water-soluble film; and
enclosing a food product with the film.

66. The method of claim 65, wherein the film can be stretched longitudinally by at least about 50% without breaking.

67. The method of claim 65, wherein the food product is enclosed by placing the food product between two pieces of film and heat-sealing the two pieces of film to form a sealed enclosure around the food product.

68. The method of claim 65, wherein the food product is enclosed by placing the food product between two pieces of film and applying moisture and pressure to at least portions of the film to form a sealed enclosure around the food product.

69. The method of claim 65, wherein the food product is enclosed by vacuum-forming the film around the food product.

70. The method of claim 65, wherein the film-forming composition comprises about 35-80% by weight pullulan on a dry solids basis.

71. The method of claim 65, wherein the film comprises about 0.5-22.5% by weight gelatin on a dry solids basis.

72. The method of claim 65, wherein the film comprises glycerol, propylene glycol, and sorbitol.

73. The method of claim 72, wherein the film-forming composition comprises about 1-30% glycerol, about 1-30% propylene glycol, and about 1-30% by weight sorbitol on a dry solids basis.

74. The method of claim 65, wherein the film-forming composition further comprises at least one salt.

75. The method of claim 74, wherein the at least one salt comprises NaCl.

76. The method of claim 74, wherein the at least one salt is present in the film-forming composition at a concentration of about 0.3-15% by weight on a dry solids basis.

77. The method of claim 74, wherein the film-forming composition further comprises at least one internal film release agent.

78. The method of claim 77, wherein the at least one internal film release agent comprises polyoxyethylene sorbitan monooleate, sodium lauryl sulfate, or a combination thereof.

79. The method of claim 65, wherein the food product is selected from powdered beverage mix, candy, powdered cheese product, powdered egg product, dry soup and casserole mixes, food dyes and spices.
